(19) United States
(12) Patent Application Publication
(10) Pub. No.: US 2026/0220214 A1
(43) Pub. Date: Jul. 30, 2026

(54) ADAPTIVE MODEL SWITCHING USING CONFORMAL INFERENCE

(71) Applicant: Microsoft Technology Licensing, LLC, Redmond, WA (US)

(72) Inventors: Suyash GUPTA, Stanford, CA (US); Rohit K PATRA, Brooklyn, NY (US); Xuexin REN, Sunnyvale, CA (US); Aman GUPTA, San Jose, CA (US); Viral GUPTA, Lathrop, CA (US)

(21) Appl. No.: 19/040,926

(22) Filed: Jan. 30, 2025

(51) Int. Cl. G06F 16/9538; G06F 16/9535

(52) U.S. Cl. CPC G06F 16/9538; G06F 16/9535

(57) ABSTRACT

Aspects of the disclosure include a recommendation service that leverages conformal inference for adaptive model switching. A method includes receiving, by a second pass ranker (SPR) of the recommendation service, a ranking request for the top K candidate items of a plurality of candidate items. The method includes generating, by a default model of the SPR, a score for each candidate items and dynamically assigning the ranking request to the default model or a backup model using conformal inference based on a prediction uncertainty of the scores generated by the default model. The backup model has at least a greater number of parameters or a greater number of layers than the default model. The method includes generating, by the assigned one of the default model and the backup model, the top K candidate items and returning, responsive to receiving the ranking request, a response comprising the top K candidate items.

### INTRODUCTION

The subject disclosure relates to machine learning and artificial intelligence, and specifically to adaptive model switching using conformal inference.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 is a functional block diagram illustrating an example of a feed service with which an embodiment of the present disclosure may be implemented and deployed;

FIG. 2 depicts a block diagram of the second pass ranker of FIG. 1 in accordance with one or more embodiments;

FIG. 3 depicts a block diagram for training the conformal inference model of FIG. 2 in accordance with one or more embodiments;

FIG. 4 depicts a block diagram of a neural network in accordance with one or more embodiments;

FIG. 5 depicts a block diagram of a transformer-type model implementation in accordance with one or more embodiments;

FIG. 6 depicts a block diagram of a computer system in accordance with one or more embodiments; and

FIG. 7 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Online platforms such as connections networks face significant technical challenges related to content serving due in part to the enormous scale of these systems and the sheer variety and amount of candidate content available for delivery to users. To illustrate these challenges, consider that online platforms would ideally only serve desired content to users (that is, content for which the receiving user is pleased to receive). To improve the desirability of delivered content, the content might be selected and delivered uniquely for each user in a personalized manner. While this might work for smaller networks (say, e.g., hundreds or thousands of users), some connections networks can serve millions or even billions of users and selecting and serving personalized content to each user quickly becomes technically difficult in terms of both request latency and the compute required.

Existing connection networks attempt to address these challenges by employing relatively lightweight models for content serving. As used herein, a lightweight model means a machine learning model designed to perform predictions with low computational cost and minimal latency. These models are characterized by having a relatively smaller number of parameters, fewer layers, and simpler architectures compared to more relatively more complex, heavyweight models. Lightweight models are favored because they offer low latency and reduced computational costs, making them suitable for handling the vast number of requests for content serving in real-time (that is, on an order of a few seconds, e.g., less than 10 seconds). These lightweight models can quickly process and rank candidate content based on various features such as individual user preferences, past interactions, and content relevance. By doing so, these models ensure that the majority of user requests are served efficiently, maintaining the overall responsiveness of the platform.

Unfortunately, reliance on lightweight models comes with its own set of limitations. While these models are efficient, they may not always capture the more complex and nuanced relationships between features, leading to suboptimal candidate predictions in certain cases. For example, lightweight models might struggle with understanding deeper contextual relationships and intricate and evolving feature interaction patterns that are crucial for accurately predicting user preferences in more complex scenarios. This can result in higher uncertainty in some predictions and a frustrating user experience.

To mitigate these issues, some connections networks have explored the use of heavyweight models, such as large language models (LLMs), which offer superior accuracy in capturing complex feature interactions and understanding deeper contextual relationships. As used herein, a heavyweight model means a machine learning model designed to maximize predictive capabilities, with compute and latency constraints being secondary considerations. In other words, a heavyweight model will have more layers, more parameters, greater architectural complexity, etc., as compared to a lightweight model. More specifically, as used herein, a heavyweight model will have at least one more internal layer, or at least 5 percent more parameters, or be trained on training data having at least 5 percent more data points than a corresponding lightweight model. Equivalently, as used herein, a lightweight model will have at least one less internal layer, or at least 5 percent less parameters, or be trained on training data having at least 5 percent less data points than a corresponding heavyweight model. Thus, heavyweight models are trained on relatively more extensive datasets and can provide more accurate and contextually rich predictions. On the other hand, their high computational costs and slower inference times make them impractical for continuous use in real-time tasks, especially at the scales desired or required for large connection networks.

This disclosure introduces a hybrid model architecture for content serving that leverages conformal inference to adaptively switch between lightweight and heavyweight models based on prediction uncertainty. The proposed system uses a lightweight model, such as a deep and cross network (DCN) model, as the default model for most predictions. The predictions (outputs) of the DCN model are passed to a conformal inference module that monitors the prediction uncertainty of the DCN outputs. When the monitored prediction uncertainty of the DCN is low, its output is accepted by the conformal inference module, ensuring low-latency decisions. On the other hand, when the prediction uncertainty is high, indicating that the DCN is likely to underperform, the conformal inference module switches to a heavyweight backup model, such as a large language model (LLM), for a more accurate prediction.

By incorporating an adaptive switching mechanism based on conformal inference, a personalized feed service can be provided at arbitrarily large scales without sacrificing prediction accuracy, content delivery latency, or compute efficiency. Notably, the majority of predictions can made by the lightweight default model. The more resource-intensive backup model is only selectively invoked for those edge cases where the lightweight model cannot satisfy statistical guarantees on prediction uncertainty. Advantageously, this approach optimizes the trade-off between accuracy and computational cost, improving prediction accuracy in difficult cases without significantly increasing the overall computational burden. In some embodiments, the conformal inference module can be configured to dynamically modify the threshold for allocating tasks between the default model and the backup model according, for example, to available compute resources. When compute is limited, the conformal inference module can relax the constraints on the prediction uncertainty of the default model. Conversely, the conformal inference module can pass relatively more tasks to the backup model when additional compute is available. Other advantages are possible.

### DETAILED EMBODIMENT

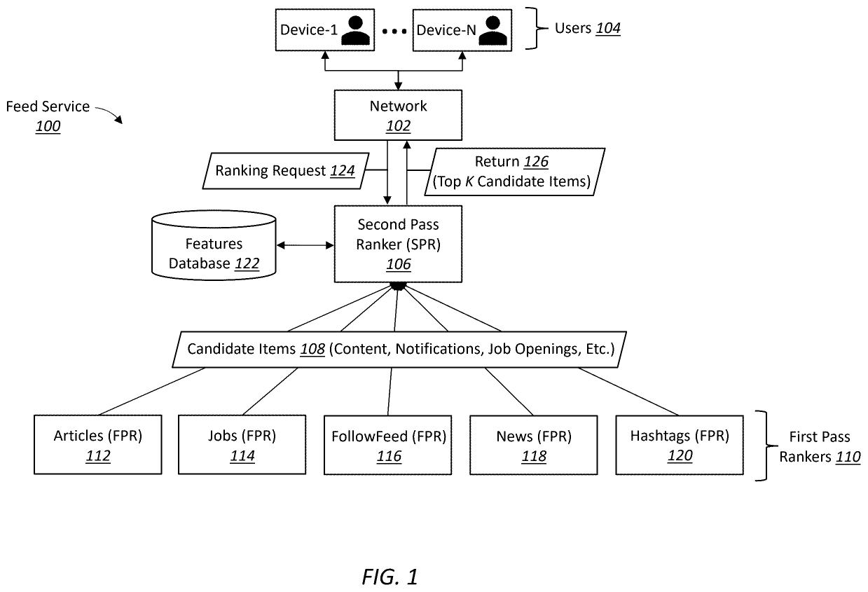

FIG. 1 is a functional block diagram illustrating an example of a feed service 100 in which an embodiment of the present invention may be implemented and deployed. The feed service 100 can be used to serve content over a network 102 to users 104. Feed service 100 can be a large-scale online service serving many users (e.g., thousands of users, millions of users, hundreds of millions of users, or more). In some embodiments, the feed service 100 may be used to customize a content feed to the attributes, behavior, and/or interests of members or related groups of members (e.g., connections, follows, schools, companies, group activity, member segments, etc.) in a connections network, social network and/or online professional network, as desired. The type of content served is not meant to be particularly limited, but can include, for example, connection recommendations (e.g., people you may know), user profiles and/or links to user profiles, job postings, user posts, status updates, user and/or system messages, sponsored content, event descriptions, articles, images, audio data, video data, documents, and/or other types of content.

Network 102 can include a data communications network and can encompass one or more different types of networks. For example, network 102 can encompass one or more cellular networks (e.g., GSM, IS-95, UMTS, CDMA2000, LTE, 5G, etc.), one or more wireless networks (e.g., an IEEE 802.11 network), and/or one or more internet protocol (IP) networks (e.g., the Internet).

User devices (e.g., Device-1, Device-2, . . . , Device-N) can be many different types of electronic personal computing devices. For example, a user device can be stationary computer such as a desktop or workstation computer or the like. A user device can be a portable computer such as a laptop computer, a tablet computer, a mobile phone, a smart phone, or the like. A user device can include, or be operatively coupled to, a computer display screen on which a graphical user interface driven by the feed service 100 can be presented to the user. The graphical user interface can encompass web pages, web content, or the like served by the feed service 100 to users 104 over network 102. The online service can drive the graphical user interface with the aid of a client application that is installed and executing the user device. The client application can be a web browser application or a mobile application, for example.

As shown in FIG. 1, feed service 100 can include a second pass ranker (SPR) 106. In some embodiments, SPR 106 is configured to score and select content for serving to the users 104 over the network 102. In some embodiments, the SPR 106 operates by re-ranking candidate items 108 that have been preliminarily selected by one or more first pass rankers (FPRs) 110. This re-ranking process ensures that the most relevant and engaging content is prioritized for delivery to users 104. In some embodiments, SPR 106 is configured to combine and score the output from one or more, or even all, of the FPRs 110.

The primary function of the FPRs 110 is to quickly and efficiently filter and rank a large pool of potential content items. In some embodiments, the FPRs 110, in contrast to the SPR 106, are each specialized in handling a specific type of content, such as articles, job postings, user posts, sponsored content, etc. The FPRs 110 operate by querying data stores to retrieve content items that match certain criteria relevant to the user. These criteria can include user preferences, past interactions, content attributes, and other contextual information. In some embodiments, each FPR 110 applies its own learned and/or heuristic ranking algorithm to score and rank the retrieved content items, producing a preliminary list of candidate items 108. This initial ranking can be based on features such as a user's engagement history, the popularity of the content, and the relevance of the content to a user's current context. For example, in some embodiments, FPRs 110 create a preliminary candidate selection (the candidate items 108) from their shared or segmented inventories based on predicted relevance to the intended user of the users 104. The candidate items 108 can be ranked using parameters related to the user's connections, groups, follows, activities, interests, associated companies, etc., in the underlying connections network, as well as other parameters such as updates made to the user's profile, job status, etc., skill recommendations by other users on the network, etc. For example, a news-type FPR might create a list of preliminary candidate news items for a user based on personalized user features such as the types and length of news content consumed by the user in the last 1, 5, 30 days, etc., in addition to non-personalized features, such as, for example, the length of a candidate news item, the type of content of a candidate news item, the time of day, the day/month of the year, etc.

In the example of FIG. 1, first pass rankers 110 include an articles first pass ranker 112 for scoring article feed items, a jobs first pass ranker 114 for scoring job feed items, a followfeed first pass ranker 116 for scoring follow feed items, a new first pass ranker 118 for scoring news feed items, and a hashtags first pass ranker 120 for scoring hashtag feed items. Article feed items scored by articles first pass ranker 112 can include user authored articles, scholarly articles, informational articles, and other types of written articles. An article feed item can contain, or link to, the text of an authored article and any associated media. Job feed items scored by the jobs first pass ranker 114 can include job opening, job postings, job listings, employment opportunities, or the like. A job feed item can contain, or link to, a text description of the job such as, for example, job requirements and any associated media. Follow feed items scored by followfeed first pass ranker 116 can include activities by users interacting with feed items in their personalized feeds. Such feed item interaction activities can include, but are not limited to, liking a feed item, sharing a feed item with one or more other users in a connections network, commenting on a feed item, and clicking on (viewing) a feed item, etc. A follow feed item can contain, or link to, a text description of a user activity and any associated media. News feed items scored by news first pass ranker 118 may include news articles, news reports, or the like. A news feed item can contain, or link to, the text of the news article and any associated media. Hashtag feed items scored by hashtags first pass ranker 120 may include social network posts, comments, tweets, photo shares, or the like that include different hashtags (e.g., “#moving”, “#selfie”, “#happy”) or other types of metadata or hashtags. A hashtag feed item can contain, or link to, the text containing a hashtag or metadata tag. First pass rankers 110 shown in FIG. 1 are provided merely as an example of a possible set of first pass rankers that can be used in the feed service 100. It should be understood that more first pass rankers, or less, or an entirely different set of first pass rankers can be used in a particular implementation, as desired. More or fewer first pass rankers 110 can also be used in a particular implementation. For example, as few as a single first pass ranker 110 can be used in an implementation.

Alternatively, more than five (5) first pass rankers 110 can be used in an implementation, such as 10, 20, 100, etc. In addition, it is not necessary for a first pass ranker 110 to score a homogeneous type of feed items, and a single first pass ranker 110 can score heterogeneous types of feed items. For example, a single first pass ranker 110 can be used to score all of article feed items, jobs feed items, follow feed items, news feed items, and hashtag feed items, as desired.

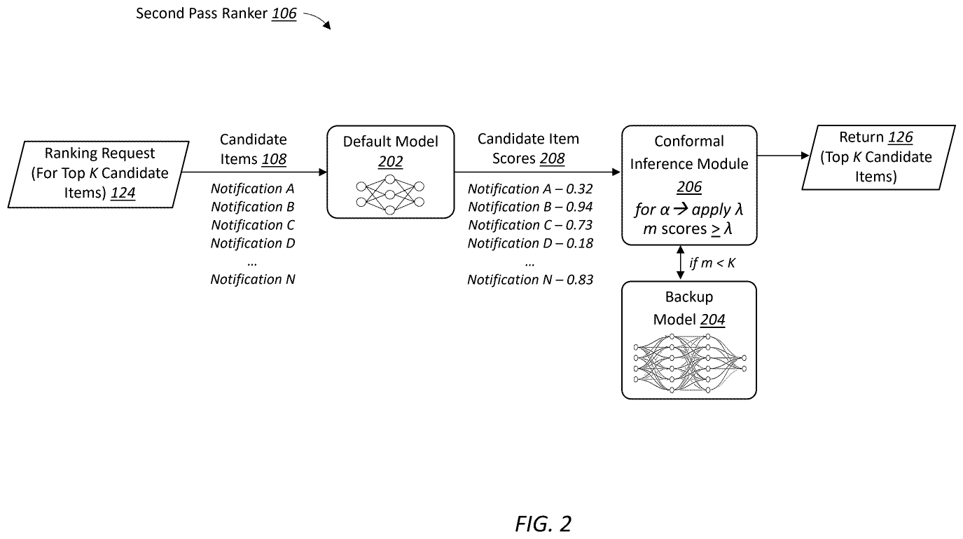

Returning now to the SPR 106, in some embodiments, SPR 106 includes one or more models (e.g., default model 202, backup model 204, refer to FIG. 2) trained or heuristically tuned to rank the candidate items 108. In some embodiments, the model(s) leverage a combination of supervised learning, unsupervised learning, and other machine learning techniques to rank the candidate items 108. A default model, such as a deep and cross network (DCN), can be trained using a large dataset of historical user interactions, where each candidate content item is labeled with engagement metrics such as clicks, likes, shares, or other relevant actions. The training process involves optimizing the model's parameters to minimize a loss function, such as cross-entropy loss, which measures the difference between the predicted scores and the actual engagement outcomes. A backup model, such as a large language model (LLM), can be similarly trained but on a more extensive dataset (e.g., a larger dataset which contains the dataset used to train the default model as well as additional training data which is not used to train the default model) to capture feature interactions and contextual relationships that can be missed by the default model.

In some embodiments, when scoring (or re-scoring) the candidate items 108, the models (default model and/or backup model) used by the SPR 106 can accept a variety of different machine learning features as input. The features accepted as input can include, but are not limited to, features of the intended user (“viewer features”), features of the candidate item (“feed item features”), features of both the user and the feed item (“viewer-feed item features”), features of the actor associated with the candidate item (“actor features”), features of both the user and the actor of the feed item (“viewer-actor features”), features combining aspects of each of the viewer, the actor, and the feed item (“viewer-actor-feed item features”), and global features. Note that, as used herein, the “actor” of a candidate item refers to the entity (e.g., another user, a company, an advertiser, etc.) that took the action(s) that caused the respective feed item to be served to the user. Note that, in some cases, the actor and the user are the same entity. On the other hand, in other scenarios, the actor and the user are different entities. In still other cases, there is no actor per se, as the feed items might be served to the user according to user and/or candidate item features and a predetermined schedule. In some embodiments, features can be stored in a features database 122 accessible to the feed service 100 and/or second pass ranker 106. In some embodiments, features database 122 can also be accessible to one or more of the first pass rankers 110.

In some embodiments, a ranking request 124 (also referred to as a personalized feed request) can be sent from or on behalf of a user device (e.g., device-1, . . . , device-N) for a user of the users 104 over network 102 to the feed service 100 and/or second pass ranker 106. In some embodiments, ranking request 124 includes a request to provide the top K candidates of a plurality of candidates (e.g., the candidate items 108) for delivery to a user of the users 104. In some embodiments, SPR 106 can, responsive to receiving the ranking request 124, return 126 (e.g., “surface”) one or more candidate items 108 to the user device over network 102, where a user can view or otherwise interact with the associated content items. The ranking request 124 can be carried in one or more hypertext transfer protocol (HTTP) requests or one or more secure-hypertext transfer protocol (HTTPS) requests. Similarly, in some embodiments, the return 126 for the personalized feed request can be sent from the feed service 100 and/or second pass ranker 106 over network 102 to the associated user device in one or more HTTP or HTTPS responses. The present disclosure is not limited to HTTP or HTTPS for sending and responding to feed requests, as these are merely illustrative. Other suitable application-layer protocols can be used such as, for example, an application-layer protocol suitable for implementing remote procedure calls (RCPs) or messaging queuing (e.g., the Advanced Message Queuing Protocol (AMQP)).

FIG. 2 depicts a block diagram of the second pass ranker 106 of FIG. 1 in accordance with one or more embodiments. As shown in FIG. 2, the second pass ranker 106 includes a default model 202, a backup model 204, and a conformal inference module 206 configured to generate a return 126 that includes the top K candidates responsive to receiving a ranking request 124.

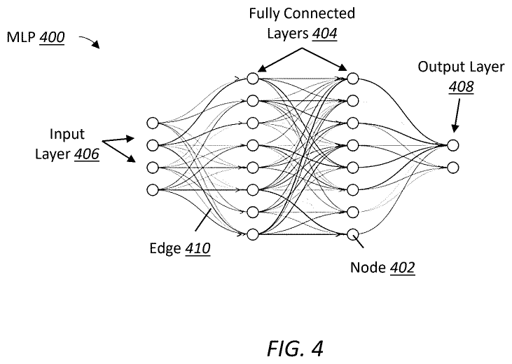

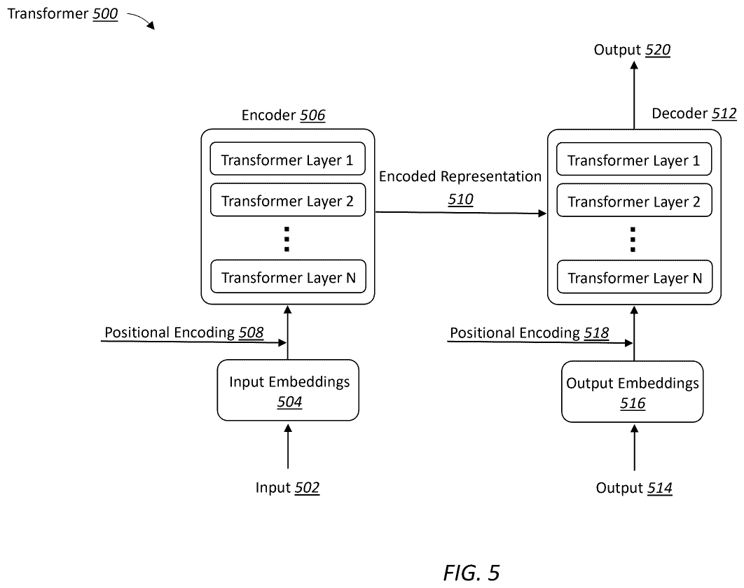

The default model 202 and backup model 204 can include for example, a variety of machine learning architectures such as deep and cross network (DCN) models, which combine deep learning with cross features to capture both low-order and high-order feature interactions, transformer models, such as some large language models (LLMs), convolutional neural networks (CNNs), recurrent neural networks (RNNs), long short-term memory networks (LSTMs), gradient boosting machines (GBMs), multilayer perceptrons (MLPs), collaborative filtering models, such as matrix factorization singular value decomposition (SVD) models, and heuristic models, which rely upon rule-based approaches using domain-specific knowledge to rank candidates based on predefined criteria. An example MLP 400 is discussed with respect to FIG. 4. An example transformer 500 is discussed with respect to FIG. 5. In some embodiments, the default model 202 and backup model 204 have different model architectures. For example, in some embodiments, the default model 202 is a DCN model and the backup model 204 is an LLM model. In other embodiments, the default model 202 and backup model 204 are both of a same model type (e.g., both can be LLMs), albeit at different complexities. For example, in some embodiments, the default model 202 is an LLM having a first number of parameters (e.g., ten thousand parameters) and the backup model 204 is an LLM having a second number of parameters greater than the first number of parameters (e.g., a billion parameters).

As discussed previously herein, the default model 202 is a relatively less complex model than the backup model 204. For example, in some embodiments, the default model 202, such as a DCN model, can be trained on fewer parameters and/or can include fewer layers, nodes, less complex hardware, etc., as compared to the backup model 204. For example, the default model 202 might include a DCN model deployed using first hardware having a first number of accelerators and the backup model 204 might include an LLM deployed using second hardware having a second number of accelerators greater than the first number of accelerators. This relatively reduced complexity allows the default model 202 to process and rank content quickly, making the default model 202 suitable for large-scale (millions of users) real-time applications where speed is critical. Additionally, or in the alternative, the default model 202 might employ simpler feature interactions and lower-order combinations than the backup model 204, focusing on capturing only the most relevant and straightforward patterns in the available dataset. In contrast, the backup model 204 can be designed to handle arbitrarily more complex and nuanced relationships and can involve higher-order feature interactions and deeper, more complete contextual understandings. The backup model 204 might also incorporate advanced architectures like transformers, which can process large sequences of data and capture long-range dependencies at the cost of increased computational resources and slower inference times.

As discussed previously, in some embodiments, second pass ranker 106 is configured to receive a ranking request 124. In some embodiments, the ranking request 124 is initially passed to the default model 202. In some embodiments, the ranking request 124 includes or is associated with a plurality of candidate items 108 and the ranking request 124 is a request for the top K candidates of the plurality of candidate items 108. The value of K is not meant to be particularly limited, but might include, for example, 5, 10, 20, 100, 500, etc., candidates. In some embodiments, the plurality of candidate items 108 includes candidates initially ranked via one or more first pass rankers 100 (refer to FIG. 1).

In some embodiments, the default model 202 is trained to output candidate scores 208 responsive to receiving the candidate items 108. For example, the candidate items 108 might include a plurality of candidate notifications (e.g., notification A, notification B, notification C, notification D, . . . , notification N) and the candidate scores 208 might include scores for these candidates: notification A—0.32, notification B—0.94, notification C—0.73, notification D—0.18, . . . , notification N—0.83. In some embodiments, the candidate scores 208 are passed to the conformal inference module 206.

In some embodiments, conformal inference module 206 receives the candidate scores 208 output from the default model 202 and determines, according to a statistical prediction uncertainty in the candidate scores 208, whether to keep the candidate scores 208 or whether to pass the ranking request 124 to the backup model 204. In other words, the conformal inference module 206 is designed to quantify prediction uncertainty and to dynamically switch between the default model 202 and the backup model 204 based on this uncertainty.

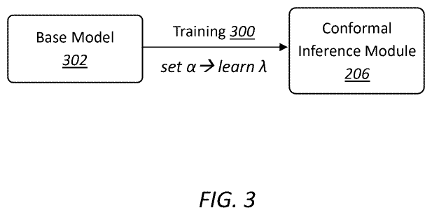

In some embodiments, conformal inference module 206 receives the candidate scores 208 generated by the default model 202 and assess the confidence of these predictions. In some embodiments, conformal inference module 206 is trained to assess the candidate scores 208 using a learned conformal inference. To illustrate, FIG. 3 depicts a block diagram for training the conformal inference model 206 in accordance with one or more embodiments.

As shown in FIG. 3, during a training phase (e.g., training 300), a base model 302 can be trained to learn a recommendation set threshold (λ) that ensures a false discovery rate (FDR) of the remaining candidates is below a predetermined threshold (α). As will be discussed in greater detail herein (refer to FIG. 3), the recommendation set threshold (λ) is a learned parameter that defines a score threshold for filtering the candidate items 108. More specifically, the recommendation set threshold (λ) sets a score threshold, below which, a candidate of the candidate items 108 is no longer considered for serving to a user of the users 104 (refer to FIG. 1).

For example, 2 might be 0.75, meaning that any candidate items 108 having candidate scores 208 below 0.75 (e.g., 0.61, 0.11, 0.74, etc.) will be removed from the list of potential top K candidates when selecting candidate items 108 for the return 126. The false discovery rate, on the other hand, measures the fraction of irrelevant items in the return 126 and the predetermined threshold (a) sets the maximum allowable false discovery rate. For example, setting the predetermined threshold (a) to a value of 5 percent means that the false discovery rate must be less than or equal to 5 percent of the total candidate items 108 included in the return 126. In the context of a false discovery rate within a recommendation system, an “irrelevant item” refers to a candidate item that is not relevant or desirable to the user receiving the candidate item. Irrelevant items can be determined according to empirical metrics, such as, for example, user engagment metrics, historical interaction data, content relevance scores, user feedback and ratings, and behavioral patterns.

User engagement metrics can include, for example, a number of clicks, a number of likes, a number of shares, a number and/or length of comments, and time spent on delivered candidate items. Historical interaction data can include past interaction data for the same candidate item and/or similar content (e.g., other content having one or more shared characteristics with a candidate item) for the user and/or similar users (e.g., those users having one or more shared characteristics with the user of interest). Content relevance scores refer to scores generated by one or more models and/or human annotators according to one or more features such as content type, topic, and user profile attributes. Direct user feedback, such as ratings or explicit feedback mechanisms, can help identify irrelevant items as well, with negative feedback and/or indications of a lack of interest or dissatisfaction with a candidate item being associated with irrelevancy. Behavioral patterns can also be used to empirically determine irrelevancy. For example, content items that, after delivery, leads to undesirable user patterns, such as exiting the platform, can be tagged as irrelevant.

Irrelevancy can also be determined by comparing any of these metrics, or any combination of these metrics, against predetermined thresholds. Irrelevant items might not align with the user's preferences, interests, or current context, and their inclusion in the return 126 can lead to a suboptimal or frustrating user experience. In other words, irrelevant items are those items that a user is unlikely to positively engage with, such as by clicking, liking, sharing, or otherwise interacting with the content, and/or is more likely to negatively engage with, such as by blocking or disabling the feed from which the irrelevant items was sourced.

In some embodiments, training 300 involves selecting a desired value for the predetermined threshold (α) and initializing the recommendation set threshold (λ) to a predetermined value that will satisfy a (if, upon checking, a is not satisfied, the default predetermined value for λ can be adjusted and a can be re-checked).

Training 300 then involves iteratively adjusting λ (learning λ) until the predetermined threshold (a) is no longer met. For example, if the predetermined threshold (α) is 5 percent and the initial value for the recommendation set threshold (λ) is 10 items, the iterative process proceeds by successively lowering the recommendation set threshold (λ) (e.g., to 9, then 8, then 7, and so forth) until the FDR exceeds 5 percent (that is, until FDR exceeds α). This training process can be referred to as a learn then test (LTT) procedure. The training process can be leveraged periodically, according to any desired re-training schedule, to update the learned the recommendation set threshold (λ) (in other words, to re-train the conformal inference module 206). For example, additional datapoints (e.g., new user interactions with candidate items) can be used to update the training data used to learn the recommendation set threshold (λ). In some embodiments, empirical measures of FDR following delivery of candidate items to users can themselves serve as additional training data during this re-training process.

In some embodiments, the default model 202 generates scores for each of a plurality of training candidates having known labels (that is, it is known empirically prior to training whether a given candidate was relevant or irrelevant) for the conformal inference module 206, and the conformal inference module 206 calculates prediction intervals for these scores. After initializing α and λ, the conformal inference module 206 then iteratively lowers λ until the FDR of the remaining training candidates exceeds α. In some embodiments, this iterative process involves determining the current value of λ, identifying the remaining set of training candidates with candidate scores 208 that meet or exceed the current λ, and comparing the FDR of this set to the predetermined α. The conformal inference module 206 adjusts λ accordingly, decreasing it when the FDR is less than a and repeating the process until the FDR exceeds α. Once the conformal inference module 206 has learned the appropriate λ for a given α, it can effectively filter candidate items 108 during an inference phase.

Returning now to FIG. 2, when a ranking request 124 is received during an inference phase, the default model 202 generates candidate scores 208 for the candidate items 108, and the conformal inference module 206 filters these candidate items 108 by removing those with scores lower than the learned λ (refer to FIG. 3). The conformal inference module 206 then compares the number of remaining candidates (m) to the desired number of top candidates (K). If m is less than K, indicating high prediction uncertainty, the conformal inference module 206 switches the ranking request 124 to the backup model 204 for a more accurate prediction.

Notably, the conformal inference module 206 switches the ranking request 124 to the backup model 204 only when the number of remaining candidates (m) is less than the desired number of top candidates (K), regardless of the underlying uncertainty in the predictions made by the default model 202. Thus, switching between the default model 202 and the backup model 204 can be tuned according to the selection of α and K. Increasing α, for example from a 5 percent maximum allowable false discovery rate to a 10 percent maximum allowable false discovery rate will result in an increase to λ (as more “irrelevant” candidate items are tolerated), and a corresponding increase in the number of remaining candidates (m) after λ filtering. Increasing the number of remaining candidates (m) increases the likelihood that m will equal or exceed K, meaning that the backup model 202 will be relied upon less often as compared to lower a values. In some embodiments, K is an empirically learned parameter to target a predetermined switching behavior for the conformal inference module 206. For example, K can be set to 10 candidate items if, during training, a K value of 10 results in at least a predetermined percentage (e.g., 50 percent, or 70 percent, or 90 percent, etc.) of the ranking requests 124 to be served by the default model 202. Note that increasing K increases the likelihood of switching to the backup model 204, while decreasing K decreases the likelihood of switching to the backup model 204. In this manner, the conformal inference module 206 allows the feed service 100 (refer to FIG. 1) to efficiently serve a majority, or any desired proportion, of ranking requests 124 using the relatively low latency default model 202, while calling upon the backup model 204 only when the learned conformal inference guarantees cannot be satisfied. This dynamic model switching architecture, based on prediction uncertainty and conformal inference, thereby enables an architecture in which the trade-off between accuracy and computational cost can be tuned as desired, ensuring efficient and accurate content delivery. The conformal inference module 206 thus minimizes the compute resources required for operating the feed service 100 without sacrificing the quality of content delivery for the more difficult edge-cases, leading to improved user satisfaction across the underlying platform.

It should be noted that, while discussed primarily in the context of content and feed serving, aspects of the second pass ranker 106, the default model 202, the backup model 204, and the conformal inference module 206 need not be limited to content serving. Other contexts for leveraging adaptive model switching via conformal inference are possible and are within the contemplated scope of this disclosure. For example, in some embodiments, the ranking request for the top K candidates need not be a request to rank candidate feed items but might instead include a request to process image or video data and to return the top K candidates matching an object recognition target. In other embodiments, the ranking request for the top K candidates might be a request to process audio data and to return the top K candidates for a phoneme recognition task. These are merely illustrative.

Turning now to FIG. 4, in some embodiments, one or more of the models (e.g., default model 202, backup model 204, etc.) previously described can be implemented in whole or in part as a multilayer perceptron (MLP) 400, which is a type of feedforward artificial neural network that consists of multiple layers of interconnected nodes 402. In this implementation, the MLP 400 includes one or more fully connected layers 404 using candidate features (refer, e.g., to candidate items 108 of FIGS. 1 and 2) as input (collectively defining an input layer 406). In this type of implementation, the output layer 408 can include candidate scores 208 (refer, e.g., to FIG. 2) for the candidate items 108. The depth, width, dimensionality, etc., of the MLP 400 need not be particularly limited, and the construction shown in FIG. 4 is merely illustrative.

In some embodiments, MLP 400 includes one or more nodes 402 (neurons) arranged in each of the fully connected layers 404. Nodes 402 in adjacent fully connected layers 404 are connected by weighted edges 410, where the weight of a respective edge represents the strength of the connection between the respective nodes 402. These weights are adjusted during a learning process (refer, e.g., to FIG. 3). In some embodiments, each node 402 in the MLP 400 performs a weighted sum of its inputs, adds a bias term, and then, optionally, applies a non-linear activation function to produce an output. The nonlinear activation function, such as a rectified linear unit (ReLU), sigmoid, or tanh function, can be applied to the outputs of each node 402 to introduce nonlinearity, allowing the MLP 400 to learn the recommendation set threshold (λ) for a given predetermined threshold (α) from complex patterns.

Turning now to FIG. 5, in some embodiments, one or more of the models (e.g., default model 202, backup model 204, etc.) previously described can be implemented in whole or in part using a transformer 500, such as those relied upon in some large language models (LLMs). In some embodiments, transformer 500 includes an encoder 506 trained to generate embeddings (e.g., candidate embeddings, user embeddings, actor embeddings, item embeddings, etc.). While not meant to be particularly limited, the transformer 500 and/or encoder 506 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

As shown in FIG. 5, the transformer 500 begins with an input 502. The input 502 denotes an input provided by a user (or upstream system) and can be represented as a sequence of tokens, individual words or sub-words, from which input embeddings 504 can be generated. The input embeddings 504 represent the tokens within the input 502 as numbers, which can be processed using encoder 506. In some embodiments, a positional encoding 508 can be generated to encode the position of each token in input 502 as a set of numbers. These numbers can be fed into the encoder 506 with the input embeddings 504, allowing the transformer-based architecture to more effectively understand the order of words in a sentence and to thereby generate grammatically correct and semantically meaningful outputs.

The encoder 506 processes the input embeddings 504 and the positional encoding 508 and generates, for the input 502, an encoded representation 510 that captures the meaning and context of the input 502. To accomplish this, encoder 506 applies a series of self-attention transformer layers (or simply, “transformer layers”), which are a series of hidden states that represent the input 502 at different levels of abstraction. The encoder 506 can include any number of these transformer layers, as desired. In some embodiments, the encoded representation 510 is provided to a decoder 512.

The decoder 512 similarly includes a number of transformer layers, as desired, except that the decoder 512 processes an output 514. In many implementations, the output 514 is a right-shifted copy of the input 502, meaning that the decoder 1112 can only use the previous words for next-token prediction. In some embodiments, output embeddings 516 can be generated from the output 514 to represent the tokens in the output 514 as numbers, in a similar manner as described with respect to the encoder 506. A positional encoding 518 can be added to the output embeddings 516 to encode the position of each token in output 514 as a set of numbers. The decoder 512 can be trained by minimizing a loss function (also known as an objective function, which quantifies a difference between a predicted output and a known true value) using, for example, gradient descent. Once trained, the transformer 500 can be used during an inference phase to generate an output 520, which can be thought of as a next-token probability (that is, how likely is the next token in the sequence to be x, or y, etc.). In some configurations, the transformer-based architecture includes a linear layer and SoftMax layer (omitted for clarity) to transform a raw output from the decoder 1112 into the output 1114. For example, after the decoder 1112 produces a raw output (e.g., output embeddings), the linear layer can map the output embeddings to a higher-dimensional space, thereby transforming the output embeddings into a same original input space as the input 1102. The SoftMax function can be used to generate a probability distribution for each output token in the vocabulary.

In the current implementation, the input 502 can include candidate items 108 (refer to FIGS. 1 and 2) and output 520 and/or encoded representation 510 can include candidate scores 208 (refer to FIG. 2). In other words, transformer 500 can be trained to generate, responsive to receiving input 502 including candidate items 108, an output 520 (or encoded representation 510 in encoder implementations) including candidate scores 208.

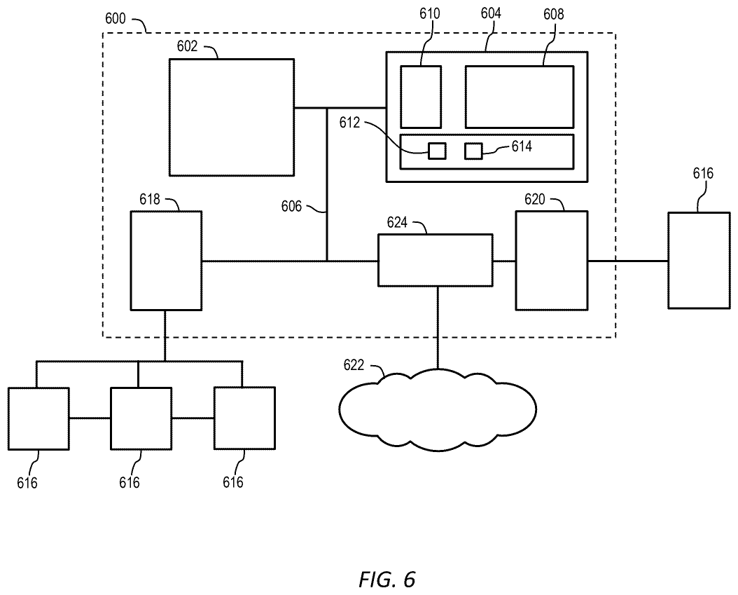

FIG. 6 illustrates aspects of an embodiment of a computer system 600 that can perform various aspects of embodiments described herein. In some embodiments, the computer system(s) 600 can implement and/or otherwise be incorporated within or in combination with the feed service 100 and/or second pass ranker 106 described previously (refer to FIGS. 1 and 2). In some embodiments, computer system 600 can be implemented server-side. For example, a remote computer system 600 can be configured to receive a ranking request 124, and in response, to generate a return 126 including the top K candidates for the ranking request 124.

The computer system 600 includes at least one processing device 602, which generally includes one or more processors or processing units for performing a variety of functions, such as, for example, completing any portion of the foundational GPT system 100 described previously. Components of the computer system 600 also include a system memory 604, and a bus 606 that couples various system components including the system memory 604 to the processing device 602. The system memory 604 may include a variety of computer system readable media. Such media can be any available media that is accessible by the processing device 602, and includes both volatile and non-volatile media, and removable and non-removable media. For example, the system memory 604 includes a non-volatile memory 608 such as a hard drive, and may also include a volatile memory 610, such as random access memory (RAM) and/or cache memory. The computer system 600 can further include other removable/non-removable, volatile/non-volatile computer system storage media.

The system memory 604 can include at least one program product having a set (e.g., at least one) of program modules that are configured to carry out functions of the embodiments described herein. For example, the system memory 604 stores various program modules that generally carry out the functions and/or methodologies of embodiments described herein. A module or modules 612, 614 may be included to perform functions related to any of the block diagrams described herein. The computer system 600 is not so limited, as other modules may be included depending on the desired functionality of the computer system 600. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 602 can also be configured to communicate with one or more external devices 616 such as, for example, a keyboard, a pointing device, and/or any devices (e.g., a network card, a modem, etc.) that enable the processing device 602 to communicate with one or more other computing devices.

Communication with various devices can occur via Input/Output (I/O) interfaces 618 and 620.

The processing device 602 may also communicate with one or more networks 622 such as a local area network (LAN), a general wide area network (WAN), a bus network and/or a public network (e.g., the Internet) via a network adapter 624. In some embodiments, the network adapter 624 is or includes an optical network adaptor for communication over an optical network. It should be understood that although not shown, other hardware and/or software components may be used in conjunction with the computer system 600. Examples include, but are not limited to, microcode, device drivers, redundant processing units, external disk drive arrays, RAID systems, and data archival storage systems, etc.

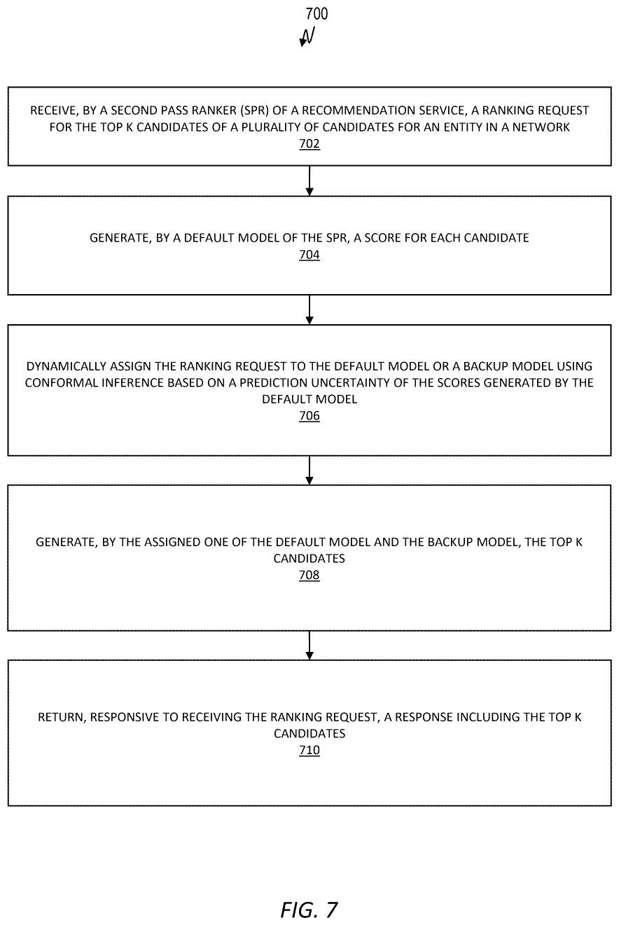

Referring now to FIG. 7, a flowchart 700 for leveraging adaptive model switching using conformal inference is generally shown according to an embodiment. The flowchart 700 is described with reference to FIGS. 1 to 6 and may include additional steps not depicted in FIG. 7. Although depicted in a particular order, the blocks depicted in FIG. 7 can be, in some embodiments, rearranged, subdivided, and/or combined.

At block 702, the method includes receiving a ranking request for the top K candidates of a plurality of candidates. In some embodiments, the ranking request is received by a second pass ranker of a recommendation service. In some embodiments, the candidates are content and/or notification candidates for delivery and/or serving to an entity in a network of the recommendation service.

At block 704, the method includes generating, by a default model, a score for each candidate. In some embodiments, the default model is a first model of a second pass ranker.

At block 706, the method includes dynamically assigning the ranking request to the default model or a backup model using conformal inference based on a prediction uncertainty of the scores generated by the default model. The backup model is relatively more complex than the default model. In some embodiments, the backup model includes at least a greater number of parameters or a greater number of layers than the default model.

At block 708, the method includes generating, by the assigned one of the default model and the backup model, the top K candidates.

At block 710, the method includes returning, responsive to receiving the ranking request, a response including the top K candidates.

In some embodiments, dynamically assigning one of the default model and the backup model using conformal inference includes filtering, by a conformal inference module, the candidates by removing candidates having respective scores, generated by the default model, lower than a recommendation set threshold (λ) that is learned such that a false discovery rate (FDR) of remaining candidates is less than a predetermined threshold (α).

In some embodiments, conformal inference further includes comparing a number m of remaining candidates after filtering to K and switching the ranking request from the default model to the backup model when m<K.

In some embodiments, the recommendation set threshold (λ) is learned during a training phase according to a learn then test (LTT) procedure. In some embodiments, the LTT procedure includes initializing the recommendation set threshold (λ) to a predetermined value, generating, by the default model, a score for each training candidate of a plurality of training candidates having known labels, and iteratively lowering the recommendation set threshold (λ) until the FDR of remaining training candidates exceeds the predetermined threshold (α).

In some embodiments, iteratively lowering the recommendation set threshold (λ) includes determining a current value of the recommendation set threshold (λ), determining a remaining set of training candidates having respective scores that satisfy the current value of the recommendation set threshold (λ), comparing the FDR of the remaining set of training candidates to the predetermined threshold (α), determining a next value of the recommendation set threshold (λ) by decreasing the current value when the FDR of the remaining set of training candidates is less than the predetermined threshold (α), and repeating the iterative process with the next value for the recommendation set threshold (λ) until the FDR of the remaining set of training candidates is more than the predetermined threshold (α).

In some embodiments, the default model is deployed using first hardware having a first number of accelerators and the backup model is deployed using second hardware having a second number of accelerators greater than the first number of accelerators. As used herein, an accelerator refers to specialized hardware components designed to enhance the performance of specific computational tasks by offloading predetermined processing types from a central processing unit (CPU), thereby speeding up the execution of some tasks and improving overall system efficiency. While not meant to be particularly limited, accelerators can include, for example, graphics processing units (GPUs), field-programmable gate arrays (FPGAs), application-specific integrated circuits (ASICs), tensor processing units (TPUs), and neural processing units (NPUs).

In some embodiments, the default model is a deep and cross network (DCN) model and the backup model is a large language model (LLM).

In some embodiments, the ranking request for the top K candidates includes at least one of a request to process image or video data and to return the top K candidates matching an object recognition target or a request to process audio data and to return the top K candidates for a phoneme recognition task.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings.

According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known.

Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

1. A method comprising:
receiving, by a second pass ranker (SPR) of a recommendation service, a ranking request for the top K candidate items of a plurality of candidate items;
generating, by a default model of the SPR, a score for each candidate item;
dynamically assigning the ranking request to the default model or a backup model using conformal inference based on a prediction uncertainty of the scores generated by the default model, wherein the backup model comprises at least a greater number of parameters or a greater number of layers than the default model;
generating, by the assigned one of the default model and the backup model, the top K candidate items; and
returning, responsive to receiving the ranking request, a response comprising the top K candidate items;
wherein dynamically assigning one of the default model and the backup model using conformal inference comprises:
filtering, by a conformal inference module, the candidate items by removing candidate items having respective scores, generated by the default model, lower than a recommendation set threshold (λ) that is learned such that a false discovery rate (FDR) of remaining candidate items is less than a predetermined threshold (α).

2. (canceled)

3. The method of claim 1, wherein dynamically assigning one of the default model and the backup model using conformal inference further comprises:
comparing a number m of remaining candidate items after filtering to K; and
switching the ranking request from the default model to the backup model when m<K.

4. The method of claim 3, wherein the recommendation set threshold (λ) is learned during a training phase according to a learn then test (LTT) procedure.

5. The method of claim 4, wherein the LTT procedure comprises:
initializing the recommendation set threshold (λ) to a predetermined value;
generating, by the default model, a score for each training candidate item of a plurality of training candidate items having known labels; and
iteratively lowering the recommendation set threshold (λ) until the FDR of remaining training candidate items exceeds the predetermined threshold (α).

6. The method of claim 5, wherein iteratively lowering the recommendation set threshold (λ) comprises:
determining a current value of the recommendation set threshold (λ);
determining a remaining set of training candidate items having respective scores that satisfy the current value of the recommendation set threshold (λ);
comparing the FDR of the remaining set of training candidate items to the predetermined threshold (α);
determining a next value of the recommendation set threshold (λ) by decreasing the current value when the FDR of the remaining set of training candidate items is less than the predetermined threshold (α); and
repeating the iterative process with the next value for the recommendation set threshold (λ) until the FDR of the remaining set of training candidate items is more than the predetermined threshold (α).

7. The method of claim 1, wherein the default model comprises a deep and cross network (DCN) model.

8. The method of claim 1, wherein the backup model comprises a large language model (LLM).

9. The method of claim 1, wherein the default model is deployed using first hardware having a first number of accelerators and the backup model is deployed using second hardware having a second number of accelerators greater than the first number of accelerators.

10. The method of claim 1, wherein the ranking request for the top K candidate items comprises at least one of a request to process image or video data and to return the top K candidate items matching an object recognition target or a request to process audio data and to return the top K candidate items for a phoneme recognition task.

11. A system comprising a memory, computer readable instructions, and one or more circuitry for executing the computer readable instructions, the computer readable instructions controlling the one or more circuitry to perform operations comprising:
receive, by a second pass ranker (SPR) of a recommendation service, a ranking request for the top K candidate items of a plurality of candidate items for an entity in a network;
generate, by a default model of the SPR, a score for each candidate item;
dynamically assign the ranking request to the default model or a backup model using conformal inference based on a prediction uncertainty of the scores generated by the default model, wherein the backup model comprises at least a greater number of parameters or a greater number of layers than the default model;
generate, by the assigned one of the default model and the backup model, the top K candidate items; and
return, responsive to receiving the ranking request, a response comprising the top K candidate items;
wherein dynamically assigning one of the default model and the backup model using conformal inference comprises:
filter, by a conformal inference module, the candidate items by removing candidate items having respective scores, generated by the default model, lower than a recommendation set threshold (λ) that is learned such that a false discovery rate (FDR) of remaining candidate items is less than a predetermined threshold (α).

12. (canceled)

13. The system of claim 11, wherein dynamically assigning one of the default model and the backup model using conformal inference further comprises:
compare a number m of remaining candidate items after filtering to K; and
switch the ranking request from the default model to the backup model when m<K.

14. The system of claim 11, wherein the recommendation set threshold (λ) is learned during a training phase according to a learn then test (LTT) procedure comprising:
initialize the recommendation set threshold (λ) to a predetermined value;
generate, by the default model, a score for each training candidate item of a plurality of training candidate items having known labels; and
iteratively lower the recommendation set threshold (λ) until the FDR of remaining training candidate items exceeds the predetermined threshold (α).

15. The system of claim 14, wherein iteratively lowering the recommendation set threshold (λ) comprises:
determine a current value of the recommendation set threshold (λ);
determine a remaining set of training candidate items having respective scores that satisfy the current value of the recommendation set threshold (λ);
compare the FDR of the remaining set of training candidate items to the predetermined threshold (α);
determine a next value of the recommendation set threshold (λ) by decreasing the current value when the FDR of the remaining set of training candidate items is less than the predetermined threshold (α); and
repeat the iterative process with the next value for the recommendation set threshold (λ) until the FDR of the remaining set of training candidate items is more than the predetermined threshold (α).

16. The system of claim 11, wherein the default model comprises a deep and cross network (DCN) model and the backup model comprises a large language model (LLM).

17. The system of claim 16, wherein the DCN model is deployed using first hardware having a first number of accelerators and the LLM is deployed using second hardware having a second number of accelerators greater than the first number of accelerators.

18. The system of claim 17, wherein the ranking request for the top K candidate items comprises at least one of a request to process image or video data and to return the top K candidate items matching an object recognition target or a request to process audio data and to return the top K candidate items for a phoneme recognition task.

19. A computer program product comprising a non-transitory computer readable storage medium having program instructions embodied therewith, the program instructions executable by one or more circuitry to cause the one or more circuitry to perform operations comprising:
receive, by a second pass ranker (SPR) of a recommendation service, a ranking request for the top K candidate items of a plurality of candidate items for an entity in a network;
generate, by a default model of the SPR, a score for each candidate item;
dynamically assign the ranking request to the default model or a backup model using conformal inference based on a prediction uncertainty of the scores generated by the default model, wherein the backup model comprises at least a greater number of parameters or a greater number of layers than the default model;
generate, by the assigned one of the default model and the backup model, the top K candidate items; and
return, responsive to receiving the ranking request, a response comprising the top K candidate items;
wherein dynamically assigning one of the default model and the backup model using conformal inference comprises:
filter, by a conformal inference module, the candidate items by removing candidate items having respective scores, generated by the default model, lower than a recommendation set threshold (λ) that is learned such that a false discovery rate (FDR) of remaining candidate items is less than a predetermined threshold (α).

20. The computer program product of claim 15, wherein dynamically assigning one of the default model and the backup model using conformal inference further comprises:
compare a number m of remaining candidate items after filtering to K; and switch the ranking request from the default model to the backup model when m<K.
